(19) United States
(12) Patent Application Publication
(10) Pub. No.: US 2017/0326750 A1
(43) Pub. Date: Nov. 16, 2017

(54) HOLDING DEVICE FOR FASTENING POLYMERIC MOTOR-VEHICLE BUMPERS

(71) Applicant: REHAU AG & CO., Rehau (DE)

(72) Inventor: Ralph SCHWARZ, Gunzenhausen (DE)

(73) Assignee: REHAU AG & CO., Rehau (DE)

(21) Appl. No.: 15/529,800

(22) PCT Filed: Oct. 1, 2015
(86) PCT No.: PCT/EP2015/001933

§ 371 Date: May 25, 2017

(30) Foreign Application Priority Data
Nov. 26, 2014 (DE) 20 2014 105 704.8

(51) Int. Cl. B26D 7/01; B26D 7/26; B26D 7/04; B26F 1/38; B26D 5/06

(52) U.S. Cl. CPC B26D 7/018; B26D 7/2614; B26D 7/04; B26D 5/06; B26F 1/38

(57) ABSTRACT

The invention relates to a holding device for fastening polymeric motor-vehicle bumpers during a machining operation, in particular a punching operation, comprising a main frame and a fastening device for fastening the bumper on the main frame. According to the invention, the fastening device has at least one fastening-arm group having at least two fastening arms movable independently of each other for different bumper models, wherein the fastening arms have different contact contours that lie against the corresponding bumper model (1) in the fastening position and the contact contour of each fixing arm is matched to the local shape of a specific bumper model.

The invention relates to a holding device for fastening polymeric motor-vehicle bumpers during a machining operation, in particular a punching operation, comprising
a main frame; and
a fastening device for fastening the bumper to the main frame.

Such a holding device is known from DE 10 2009 019 644 A1. Such holding devices are, for example, used to fasten a motor-vehicle bumper in a punching machine for the purpose of introducing recesses for parking sensors, spacers or the like. The holding devices known in the prior art are with respect to their geometry matched to a single bumper production model of a specific motor-vehicle production series. Therefore, it is not possible to fasten various motor-vehicle bumper models in one and the same holding device. This is particularly disadvantageous in the production of bumpers for the spare parts service because despite of only small quantities of each bumper model a separate punching machine comprising a holding device which is specifically matched to this bumper model has to be provided. The adverse consequence is on the one hand a high capital commitment and on the other hand a very large amount of space.

In order to make the punching process itself flexible it is known from WO 2014/169999 A1 to mount punching tools on a movable and replaceable carrier, whereby a variable processing of different bumper models on one and the same punching machine is enabled.

In the light of the described background it is the object of the present invention to provide a holding device including the features described above, which can be flexibly matched to different motor-vehicle bumper models.

According to the invention the object is achieved in that the fastening device comprises at least one fastening arm group comprising at least two fastening arms movable independently from each other for different bumper models, wherein the fastening arms include different contact contours abutting against the corresponding bumper model in the fastening position and the contact contour of the fastening arms is respectively matched to the local shape of a specific bumper model. The invention thus provides a plurality, preferably four, fastening arms movable independently from each other within a fastening arm group in order to provide a flexibility in terms of the optional fastening of four different motor-vehicle bumper models. When fastening a special bumper model only that fastening arm of the fastening arm group is used, the contact contour of which is matched to the local shape of this specific bumper model. The other fastening arms on the other hand are still located in the basic position during the fastening of this bumper model and are not needed for fastening this specific bumper model. By selecting the appropriate movable fastening arm it is thus possible to fasten different motor-vehicle bumper models in the same holding device. This is particularly advantageous if the holding device is used for the production of various motor-vehicle bumper models in the spare parts service.

Appropriately, the fastening device includes a plurality of, preferably three, fastening arm groups by means of which the bumpers can be fastened on the main frame at several points spaced from each other. Appropriately, three fastening arm groups are provided which fasten the corresponding motor-vehicle bumper model in all three spatial directions. When fastening a specific motor-vehicle bumper model only that fastening arm is transferred to the working position the contact contour of which is specifically matched to the local shape of exactly this bumper model. Thus, by means of transferring the fastening arms exactly matched to the specific bumper model from the basic position to the working position a secure fastening of this bumper can be provided. If another bumper model is to be fastened in a next step, at first the fastening arms matched to the previous bumper model are transferred again to the basic position and then the fastening arms matched to the subsequent bumper model are transferred to the working position. Depending on the number of fastening arms per fastening arm group thus a corresponding number of different bumper models can be fastened on the same holding device.

According to a preferred embodiment of the invention the fastening arms are connected pivotally to the main frame, for example, by means of a respective ball bearing. Appropriately, each fastening arm can be transferred separately from preferably substantially vertical basic position to a preferably substantially horizontal fastening working position. Here, the pivotal movement can be effected respectively via a pinion which is arranged on the fastening arm and connected to a pneumatic drive by means of a rack.

According to a preferred embodiment of the invention the fastening device additionally comprises at least two side fastening units each comprising at least two side fastening elements which serve for the model specific fastening of the side surfaces of the bumper. By means of this it is possible to securely lock the side surfaces (ears) of the bumper during the machining operation, preferably a punching operation. Here, the arrangement principle can take place analogously to the fastening arm group including the fastening arms, i.e. appropriately a contour matched side fastening element per side fastening unit is provided for each specific car bumper model, which is used only for lateral fastening of the respective bumper model.

Appropriately, the fastening arms each include at least one vacuum fastening element in the area of the contact contour, which is connected to a preferably central vacuum system. In this way, the motor-vehicle bumper can be fastened securely in the contact area of the fastening arm by means of vacuum such that an exact machining is possible.

In order to ensure maximum flexibility, the fastening arms are appropriately arranged removable on the main frame, so that these are replaceable for the purpose of matching the holding device to different bumper models. Thus, a large assembly of fastening arms can be kept in stock in order to match the holding device to almost any number of different bumper models. In particular, in the frame of the spare parts service thereby the advantage arises that by use of a single holding device a large number of different motor-vehicle bumper models can be machined.

Subject matter of the invention is also a machine, in particular a punching machine, comprising at least one holding device according to the invention.

In the following the invention is explained in detail with reference to a drawing showing merely an exemplary embodiment; the drawing schematically shows:

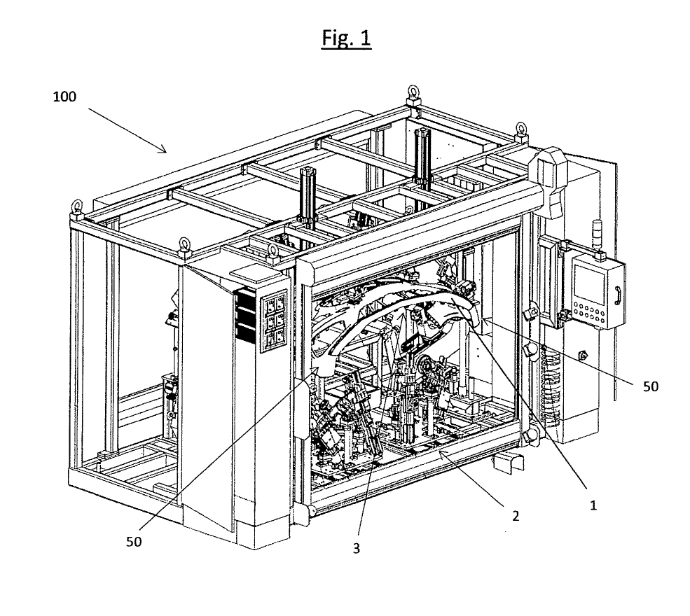

FIG. 1 shows a punching machine for machining a polymeric motor-vehicle bumper according to the prior art,

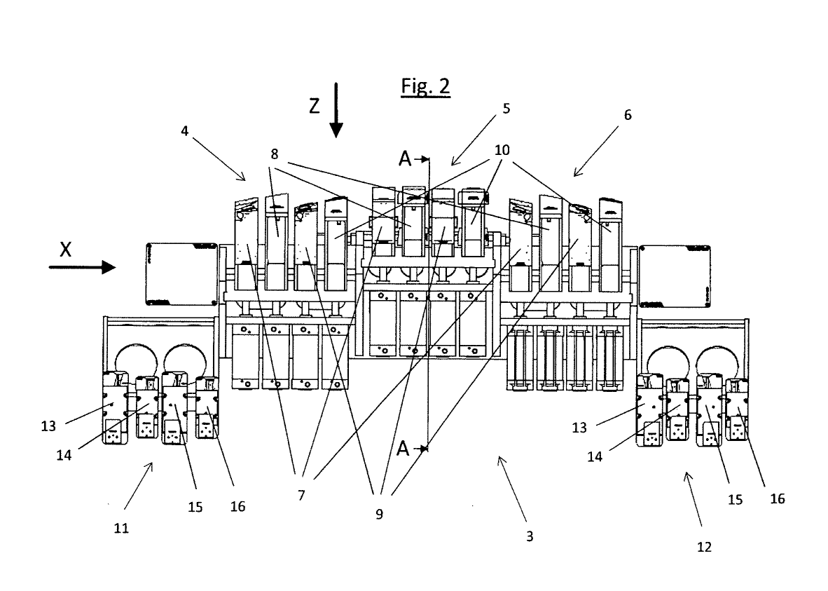

FIG. 2 is a side view of a holding device according to the invention;

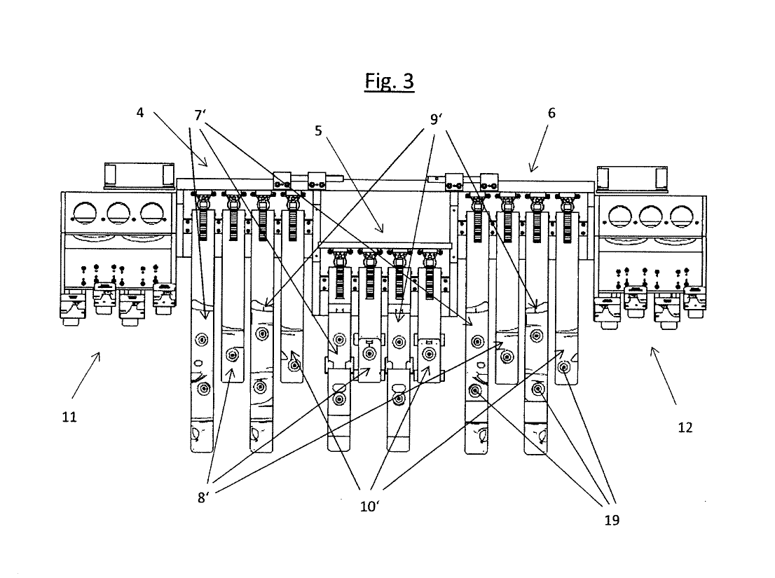

FIG. 3 is a plan view Z of the holding device shown in FIG. 2;

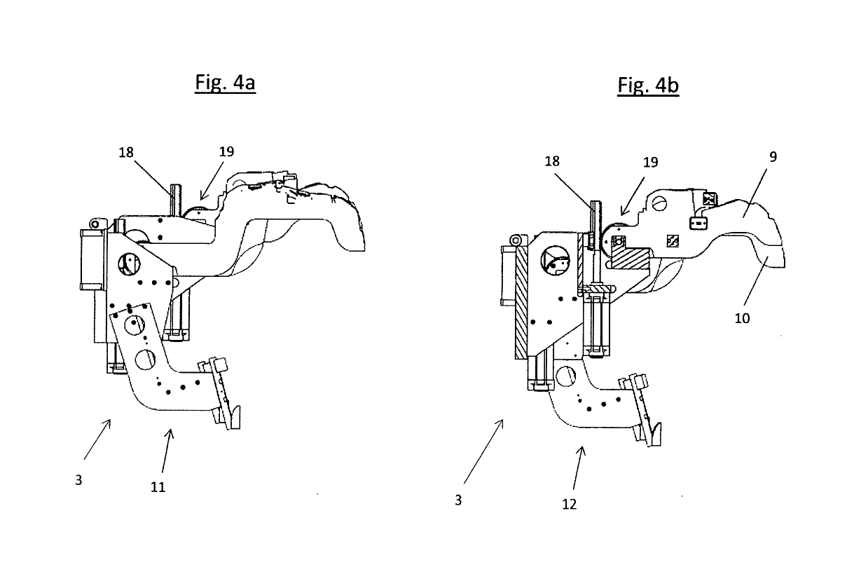

FIG. 4a shows the view X in FIG. 2; and

FIG. 4b shows the section A-A in FIG. 2.

FIG. 1 shows a punching machine 100 for processing polymeric motor-vehicle bumpers. This punching machine 100 comprises a holding device for fastening the motor-vehicle bumpers 1. The holding device comprises a main frame 2 and a fastening device 3 for fastening the bumper 1 on the main frame 2. The shape of the fastening device 3 is specifically matched to the specific motor-vehicle bumper model 1.

FIG. 2 shows a holding device according to the invention for fastening polymeric motor-vehicle bumpers 1 during a punching process. The holding device comprises a main frame 2 not shown in detail in FIG. 2 and a fastening device 3 for fastening the bumper 1 on the main frame 2. The holding device according to the invention is part of a machine for processing the polymeric vehicle bumpers. This machine can be a pure punching machine or else a machine by means of which a number of different processing steps may be carried out with respect to the bumpers 1. FIG. 2 shows that the fastening device comprises three fastening arm groups 4, 5, 6 each comprising four independently movable fastening arms 7, 8, 9, 10 for different bumper models. The fastening arms 7, 8, 9, 10 have different contact contours 7′, 8′, 9′, 10′ which in the fastening position abut against the corresponding motor-vehicle bumpers 1, wherein the contact contour 7′, 8′, 9′, 10′ of the fastening arms 7, 8, 9, 10 is respectively matched to the local shape of a specific bumper model 1. This can be seen in particular with reference to the plan view in FIG. 3.

In FIGS. 2 and 3 all fastening arms 7, 8, 9, 10 are in a horizontal fastening working position. In fastening a concrete motor-vehicle bumper model 1, however, per fastening arm-group 4, 5, 6 only one, namely the fastening arm matched exactly to this motor-vehicle bumper model, is transferred from the basic position into the working position, while the other three fastening arms each remain in their vertical basic position. The fastening arms 7, 8, 9, 10 are pivotally connected to the main frame 2 in order to be able to transfer them respectively from the basic position into the working position. For fastening a particular bumper model 1, for example, the fastening arms 7 shown in FIG. 3 on the left side are transferred with their corresponding matching contact contours 7′ into the horizontal working position in order to fasten the specific bumper 1. The other fastening arms 8, 9, 10 on the other hand are located in the vertical basic position during the fastening of this bumper 1. However, if it is desired to fasten a bumper model 1 to whose contour the contact contours 8′ of the respective second fastening arms 8 from the left side are matched, accordingly for fastening this bumper model 1 only these fastening arms 8 are transferred into the horizontal working position, whereas the other fastening arms 7, 9, 10 remain in the basic position, etc. Additionally, at the two ends of the fastening device 3 respective side fastening units 11, 12 each comprising four side fastening elements 13, 14, 15, 16 are provided which enable a model matched fastening of the side surfaces 50 (ear) of the bumper 1 (see FIG. 1). Here again, only that side fastening element is brought into use the contour of which is matched exactly to the bumper model 1 which is specifically to be fastened.

From a comparative examination of FIGS. 2 and 3 it can be seen further that the pivotal movement of the fastening arms 7, 8, 9, 10 is implemented by means of a pinion 17 arranged on the fastening arm 7, 8, 9, 10, which by means of a rack 18 is connected to a pneumatic actuator not shown in detail. In this context, it is particularly referred to the side view of FIG. 4a and the cross section A-A in FIG. 2 according to FIG. 4b. If the rack 18 is respectively displaced upwardly, in FIG. 4a, b a clockwise rotation of the pinion 17 and hence a pivotal movement of the respective fastening arms 7, 8, 9, 10 into the horizontal working position takes place. If, however, the rack 18 is moved downwardly by the pneumatic drive, this results in an anticlockwise rotation of the pinion 17 and the respective fastening arm 7, 8, 9, 10 thus performs a pivotal movement into the vertical basic position.

In particular, from FIG. 3 it is apparent that the fastening arms 7, 8, 9, 10 in the area of the contact contour 7′, 8′, 9′, 10′ each comprise a plurality of spaced apart vacuum fastening elements 19. All vacuum fastening elements 19 are connected to a central vacuum system (not shown). In order to fasten a specific motor-vehicle bumper model 1—as already described above—first the fastening arms 7, 8, 9, 10, the contact contours 7′, 8′, 9′, 10′ of which are exactly matched to this model, are transferred into the horizontal working position, then the bumper 1 is placed on these fastening arms 7, 8, 9, 10 and then fastened by means of the negative pressure generated by the vacuum system. Here, the bumper 1 is pressed against the contact contours 7′, 8′, 9′, 10′ of these fastening arms 7, 8, 9, 10 which are matched to the bumper. Thereafter, the side surfaces 50 (ears) of the bumper 1 are fastened by means of correspondingly matched side fastening elements 13, 14, 15, 16. In this securely and accurately fastened state of the bumper 1 a highly accurate machining, in particular a punching process, is possible.

The fastening arms 7, 8, 9, 10 are removably arranged at the main frame 2, so that these are interchangeable for the purpose of matching the holding device to different bumper models 1.

1. Holding device for fastening polymeric motor-vehicle bumpers during a machining operation, in particular a punching operation, comprising
a main frame; and
a fastening device for fastening the bumper on the main frame;
characterized in that
the fastening device comprises at least one fastening arm group including at least two fastening arms for different bumper models and movable independently from each other, wherein the fastening arms include different contact contours abutting against the corresponding bumper model in the fastening position, and wherein the contact contours of the fastening arms are respectively matched to the local shape of a particular bumper model.

2. Holding device according to claim 1, characterized in that the fastening device comprises a plurality of, preferably three, fastening arm groups by means of which the bumper can be fastened at several spaced apart points on the main frame.

3. Holding device according to claim 1, characterized in that the fastening arms are pivotally connected to the main frame.

4. Holding device according to claim 3, characterized in that by means of a pivotal movement each fastening arm can be separately transferred from a preferably substantially vertical basic position into a preferably substantially horizontal fastening working.

5. Holding device according to claim 4, characterized in that the pivotal movement is performed respectively by means of a pinion arranged on the fastening arm, wherein the pinion is connected to a pneumatic drive by means of a rack.

6. Holding device according to claim 1, characterized in that the fastening device additionally comprises at least two side fastening units each comprising at least two side fastening elements which serve for a model specific fastening of the side surfaces of the bumper.

7. Holding device according to claim 1, characterized in that the fastening arms in the area of the contact contour respectively comprise at least one vacuum fastening element which is connected to a preferably central vacuum system.

8. Holding device according to claim 1, characterized in that the fastening arms are removably arranged at the main frame so that they are replaceable for the purpose of matching the holding device to different bumper models.

9. A punching machine, comprising at least one holding device for fastening polymeric motor-vehicle bumpers during a punching operation, comprising:
a main frame; and
a fastening device for fastening the bumper on the main frame;
characterized in that
the fastening device comprises at least one fastening arm group including at least two fastening arms for different bumper models and movable independently from each other, wherein the fastening arms include different contact abutting against the corresponding bumper model in the fastening position, and wherein the contact contours of the fastening arms are respectively matched to the local shape of a particular bumper model.

10. The punching machine according to claim 9, characterized in that the fastening device comprises a plurality of, preferably three, fastening arm groups by means of which the bumper can be fastened at several spaced apart points on the main frame.

11. The punching machine according to claim 9, characterized in that the fastening arms are pivotally connected to the main frame.

12. The punching machine according to claim 11, characterized in that by means of a pivotal movement each fastening arm can be separately transferred from a preferably substantially vertical basic position into a preferably substantially horizontal fastening working.

13. The punching machine according to claim 12, characterized in that the pivotal movement is performed respectively by means of a pinion arranged on the fastening arm, wherein the pinion is connected to a pneumatic drive by means of a rack.

14. The punching machine according to claim 9, characterized in that the fastening device additionally comprises at least two side fastening units each comprising at least two side fastening elements which serve for a model specific fastening of the side surfaces of the bumper.

15. The punching machine according to claim 9, characterized in that the fastening arms in the area of the contact contour respectively comprise at least one vacuum fastening element which is connected to a preferably central vacuum system.

16. The punching machine according to claim 9, characterized in that the fastening arms are removably arranged at the main frame so that they are replaceable for the purpose of matching the holding device to different bumper models.
